(19) United States
(12) Patent Application Publication
(10) Pub. No.: US 2026/0351868 A1
(43) Pub. Date: Nov. 5, 2026

(54) CONNECTION DEVICE FOR CONDUCTORS

(71) Applicant: Weidmüller Interface GmbH & Co. KG, Detmold (DE)

(72) Inventors: Michael HERRMANN, Detmold (DE); Jan BRÜNTRUP, Schloß Holte-Stukenbrock (DE); Heike SCHMIDTPOTT, Bad Salzuflen (DE); Robin REINKE, Detmold (DE)

(21) Appl. No.: 19/664,853

(22) Filed: Apr. 30, 2026

(30) Foreign Application Priority Data
May 5, 2025 (DE) 102025117127.0

(51) Int. Cl. H01R 4/48

(52) U.S. Cl. CPC H01R 4/4811

(57) ABSTRACT

A connection device, configured as a direct plug-in spring force terminal, for connecting a conductor, in particular a stranded conductor, includes a housing, a busbar, and a connection spring. The connection spring includes an approximately V-shaped clamping spring, acting as a compression spring, for fixing the electrical conductor in the spring force terminal and a retaining spring for latching the clamping spring in an open and latching position. The clamping spring has a clamping leg, which can be pivoted in and counter to a pivot direction, with a clamping edge and the retaining spring has a pivotable retaining leg, which can be releasably latched on the clamping leg. The retaining leg has two retaining mechanisms as latching mechanisms and the clamping leg has two corresponding counter-retaining mechanisms as counter-latches which interact with the retaining mechanisms of the pivoting leg in the open and latching position of the clamping leg. Two latching wings are provided which project laterally from opposite narrow sides of a transverse-leg section of the retaining leg, and the transverse-leg section is aligned transversely to the conductor insertion direction, with the latching wings being bent over counter to the conductor insertion direction The wings having latching hooks with latching edges in the direction of the conductor insertion channel, which can be latched on latching webs of the clamping leg as the counter-latches.

### BACKGROUND

The present invention relates to a connection device for electrical conductors.

Connection devices such as direct plug-in spring force terminals (push-in) with a pressure spring and clamping spring which include pressing the conductor against the busbar are known.

Latching of the clamping springs or compression springs in an open and latching position such that a conductor can be easily guided into a contact region is also known. This latching takes place by an actuation mechanism such as a pusher, which can be latched on the terminal housing, wherein the pusher holds the clamping leg in the open and latching position. By releasing the actuation mechanism after the conductor has been introduced, the clamping leg can relax and press the conductor against the busbar. However, it is disadvantageous that the actuation mechanism has to be released manually in order to contact the conductor.

EP 2 466 689 A1 discloses a spring force terminal in which a single-piece clamping spring is latched on a clamping edge of a clamping leg of the clamping spring. A disadvantage of this configuration of the latching of the clamping leg is the relatively high wear of the clamping edge of the clamping spring, which occurs during the wiring of the spring force terminal.

WO 2021/105280 A1 also discloses a spring force terminal in which a single-piece clamping spring is latched on the spring leg of the clamping spring, wherein the latching mechanism of the clamping leg is configured spaced apart from the clamping edge of the clamping leg. In this way, a spring force terminal is provided which separates the latching mechanism of the clamping spring from the clamping edge in order to press the conductor against a busbar and advantageously reduces the wear of the clamping edge of the clamping spring as a result of this functional separation. This spring force terminal has proven to be effective per se. However, there is a need for a spring force terminal that can also be used well in an installation space which is very restricted perpendicularly to the conductor insertion direction.

### SUMMARY OF THE INVENTION

Accordingly, it is an object of the present disclosure to provide a spring force terminal for conductors, in particular for stranded conductors, and which is also suitable for installation in housings in which a relatively small installation space is available perpendicular to the conductor insertion direction.

In this way, a compact connection device can be realized by direct plug-in technology which can be triggered by the conductor, and which is also suitable for conductors with a relatively small cross-section, since the trigger forces can be kept low.

According to one embodiment, the latching hooks of the retaining leg can be latched with their latching edges on latching webs projecting laterally from narrow sides of the clamping leg.

In another embodiment, the two latching wings which project laterally from opposite narrow sides of a transverse-leg section of the retaining leg extend in a planar manner substantially in parallel planes. These measures also assist in realizing a compact connection device by direct plug-in technology which can be triggered by the conductor, and which is also well suitable for conductors with a relatively small cross-section, since the trigger forces can be kept low.

According to a further embodiment, the clamping leg of the clamping spring and the retaining leg of the retaining spring each have at least one leg section which are aligned in such a way that they lie substantially parallel to one another in the open and latching position, these leg sections extending substantially in the conductor insertion direction and in a direction perpendicular thereto. This simple design measure further contributes to a compact structure and also helps to achieve low trigger forces for releasing the latch.

In another embodiment, the latch of the clamping leg is spaced apart from the clamping edge of the clamping leg counter to the conductor insertion direction, such that the retainer of the pivoting leg is not latched directly on the clamping edge of the clamping leg. Therefore, a spring force terminal is created which, in an advantageous functional separation, separates the latching mechanism of the clamping spring from the clamping edge in order to press the conductor against a busbar and advantageously reduces the wear of the clamping edge of the clamping spring. In this respect, it is advantageously provided that the retainer of the pivoting leg is latched not directly on the clamping edge of the clamping leg but rather offset thereto counter to the conductor insertion direction. In this way, the retainer cannot rub on the clamping edge when it is released from the clamping edge. The clamping edge is thus protected in a simple manner from excessive wear as a result of a wiring process.

In yet another embodiment, the clamping spring is configured in one piece with the retaining spring to achieve an advantageously simple structural design of the clamping spring. This results in a simple mounting process of the clamping spring and cost-effective production of the clamping spring.

In a related embodiment, the latch or the first latching mechanism and/or the corresponding counter-latching mechanism have one or more corresponding rounded portions or chamfers.

In one embodiment, the clamping spring has a support leg that supports it on a corresponding abutment of the housing and/or of the busbar.

In a particular embodiment, the busbar has a U-shape in a side view and preferably forms a clamping cage, which is U-shaped in a side view, with the contact leg, a base leg and an abutment leg.

In another embodiment, the receiving chamber of the housing tapers in the conductor insertion direction, and the U-shaped clamping cage likewise tapers out of the busbar in the conductor insertion direction. This also contributes to a compact structure.

In a further embodiment, the clamping spring has a bend, which extends over 180° and connects the clamping leg to the support leg. The pusher acts on the bend or on a transition region between the bend and the clamping leg when the open and latching position is restored.

In a preferred embodiment, the bend extends in the transverse direction into a region which is located above an upper end of the abutment leg of the clamping cage out of the busbar.

In yet another embodiment, the actuating element acts on the actuating leg above the axis of rotation of the clamping spring.

In one embodiment, the actuating element acts on a point of the clamping leg which is located in the first half of the actuating leg in the conductor insertion direction.

In another embodiment, the actuating element is arranged substantially above the axis of rotation of the clamping spring.

These measures also serve, individually or together, for the compact structure, which is narrow, in particular transversely to the conductor insertion direction, and for realizing low trigger forces.

According to a further preferred embodiment, the actuating element has in the conductor insertion direction a base leg which is oriented in the housing parallel to the conductor insertion direction and merges into an actuation leg angled obliquely with respect to the conductor insertion direction or with respect to the conductor insertion direction towards the clamping leg and with which the pusher acts on the clamping spring.

In a particular embodiment, when the clamping leg is stressed in the open and latching position, the length of the clamping spring is more than twice as great as the distance between the clamping edge and the abutment leg in a transverse direction transversely to the conductor insertion direction.

In another embodiment, the retaining leg of the retaining spring forms a lever arm which is more than half as long as the clamping leg in the conductor insertion direction in the tensioned state.

These measures also serve, individually or together, for the narrow compact structure, in particular transversely to the conductor insertion direction, and for realizing low trigger forces.

It is further an object of the present disclosure to provide a series terminal or a plug connector or a connection strip having one or more connection devices.

A plug connector or a connection strip is provided with a plurality of connection devices. Two connection devices share a housing base part and are arranged in receiving chambers which are open toward opposite directions of the housing base part.

In a second embodiment, the housing upper part has a chamber-like structure, with walls which separate the receiving chambers of the respective housing base part toward opposite sides and optionally in the middle.

According to a further preferred embodiment variant of the invention, the clamping spring can have a support leg, with which it is supported on a corresponding abutment. The abutment can be an abutment leg of the busbar. However, it can also be provided that the abutment is the terminal housing.

As a result of the fact that the retaining spring can have a pressure surface which can be arranged transversely to the conductor insertion direction or conductor insertion direction, a simple, effective and therefore advantageous possibility for unlatching the clamping spring by the conductor end is created. It is likewise advantageous if the retainer is integrally formed on the pivoting leg. This results in a simple structural implementation of the retainer on the pivoting leg.

In this way, too, the triggering and latching characteristics of the conductor connection can be optimized further.

Another aspect of the disclosure relates to a series terminal or a plug connector having one or more spring force terminals.

### BRIEF DESCRIPTION OF THE DRAWINGS

The invention is described in greater detail below with reference to the drawings. In the drawings:

FIG. 1 is a side view of an assembly of a first connection device according to the invention as a direct plug-in spring force terminal (push-in) with a clamping leg in an open and latching position;

FIG. 2 is a perspective view of the arrangement from FIG. 1;

FIG. 3 is a further perspective view of the arrangement from FIGS. 1 and 2;

FIG. 4 is a plan view of the arrangement from FIGS. 1 and 2;

FIG. 5 is a perspective view of a connection spring of the arrangement from FIG. 1;

FIGS. 6a-6c are various views of a second exemplary embodiment, similar to FIGS. 1 to 3, of an assembly of a first connection device according to the invention as a direct plug-in spring force terminal (push-in) with a clamping leg in an open and latching position; and

FIGS. 7a-7f are various views of a third exemplary embodiment of a section of a connection device according to the invention as a direct plug-in spring force terminal (push-in) with a clamping leg in an open and latching position, and in a clamping position with and without an inserted conductor.

### DETAILED DESCRIPTION

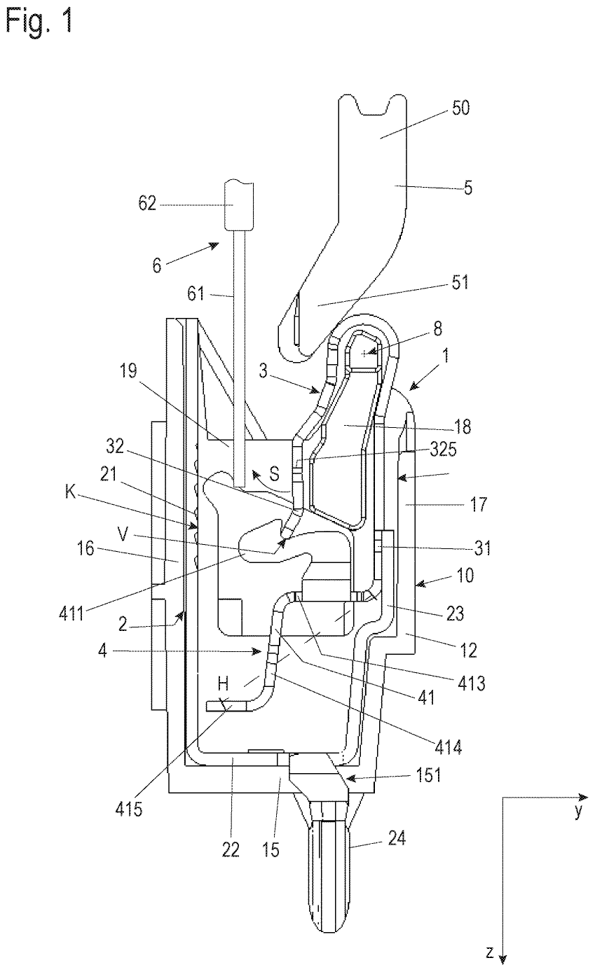

Referring to FIG. 1, there is an assembly of a connection device 1, configured as a direct plug-in spring force terminal, for an electrical conductor 6. In particular, a housing upper part is not shown in FIG. 1.

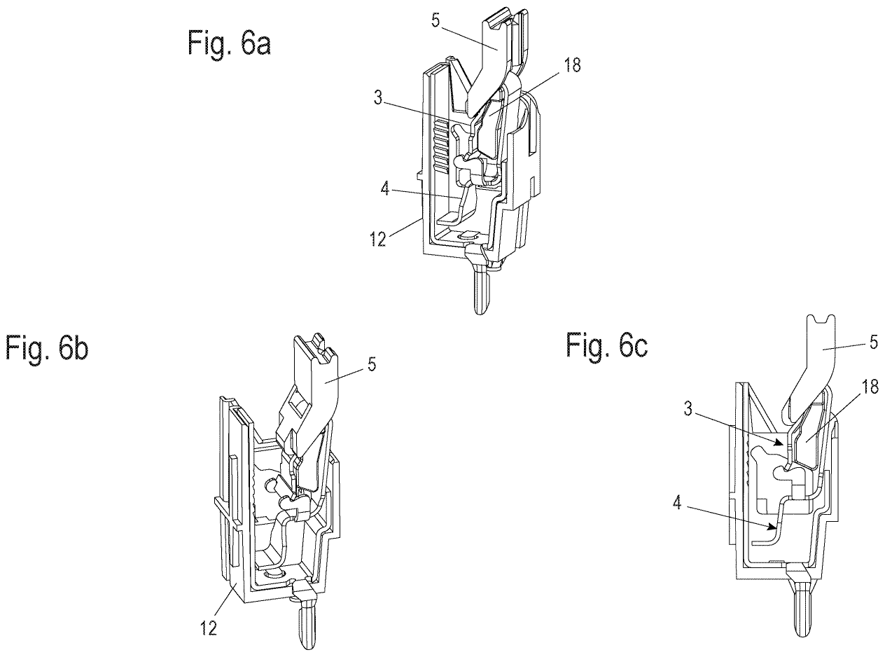

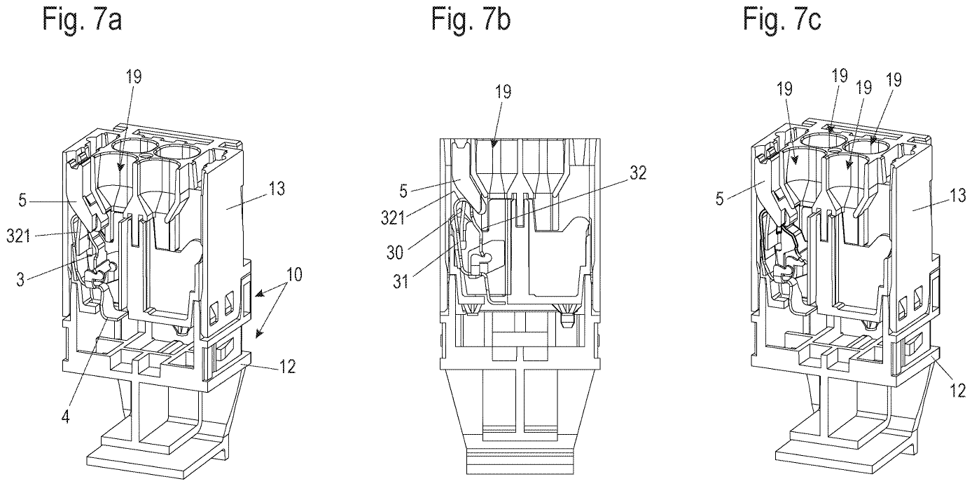

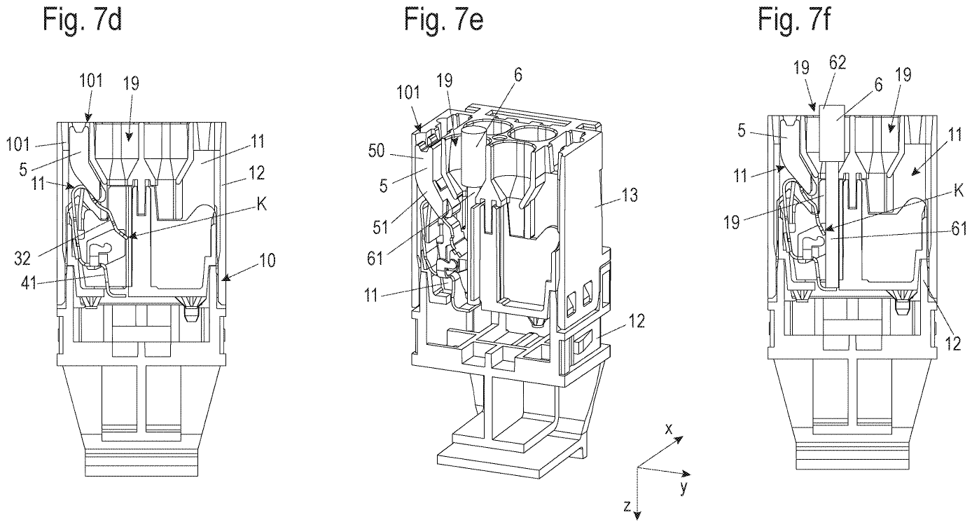

By way of example, the invention is described here in a compact manner, but it is not restricted to this embodiment. Individual advantageous features of the exemplary embodiment described below can also be implemented in other exemplary embodiments (e.g. FIGS. 6a, 7a) in addition to the exemplary embodiment shown.

A Cartesian coordinate system (X-/Y-/Z) is used for orientation. Terms such as top and bottom or left and right relate to the orientation in FIG. 1. They transform in space during rotations of the spring force terminal 1.

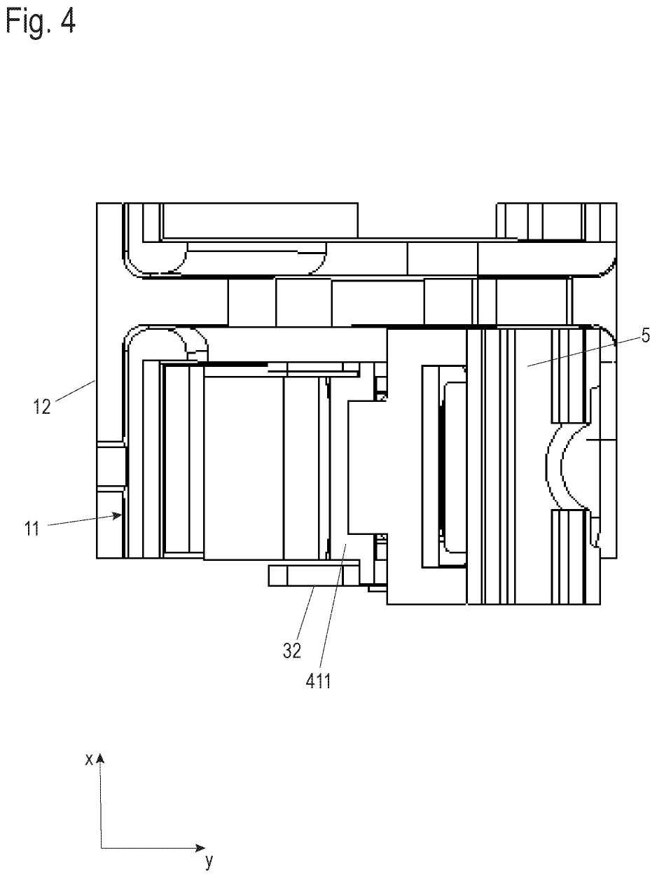

The direct plug-in spring force terminal has a connection spring with a clamping spring 3, a retaining spring 4 (see FIG. 4), and a housing 10.

The connection spring is inserted into a free space in a receiving chamber 11 of the single-part or multi-part housing 10, which is preferably multi-part having a housing lower part 12 and a housing upper part 13, as shown in the exemplary embodiment of FIG. 7a.

The connection spring can be produced from a spring band material, such as a steel band material, with a thickness of 0.2 to 0.4 mm, preferably a thickness of 0.25 mm.

The respective connection device 1 has a busbar 2 for contacting the electrical conductor 6 to be connected. The busbar is likewise inserted into the receiving chamber 11 and forms an abutment for the electrical conductor 6, which is pressed against the busbar 2 by the clamping spring 3 acting as a compression spring.

The conductors 6 to be connected are configured as stripped conductor ends. These conductor ends can also be configured as fine-wire conductors or stranded conductors. However, the spring force terminal is also suitable for single-wire conductors. Optionally, conductors with core end sleeves can also be clamped. The conductors 6 can be guided into the housing 10 in a conductor insertion channel 19, which can extend both in the housing upper part 13 and in the housing lower part 12 (see also FIGS. 7e and 7f).

The connection device 1 can be used in various ways, for example as one of a plurality of connection devices of a multi-pole plug connector. The connection device 1 can also be used as a connection device of another device, for example, as a connection device 1 of a series terminal.

Preferably, the cross-section of the conductors to be connected can be relatively small, for example, between 0.25 mm and 2.5 mm. A preferred application includes the connection device 1 being suitable for connecting conductors with a cross-section of 0.25 mm to 1.5 mm² and a connection device of a multi-pole plug connector which has a plurality of connection devices in a housing with a common housing upper part. These connection devices lie next to one another in a row in the X direction, perpendicular to a conductor insertion direction Z, while abiding by the prescribed air gaps and creepage distances, taking into account the housing 10.

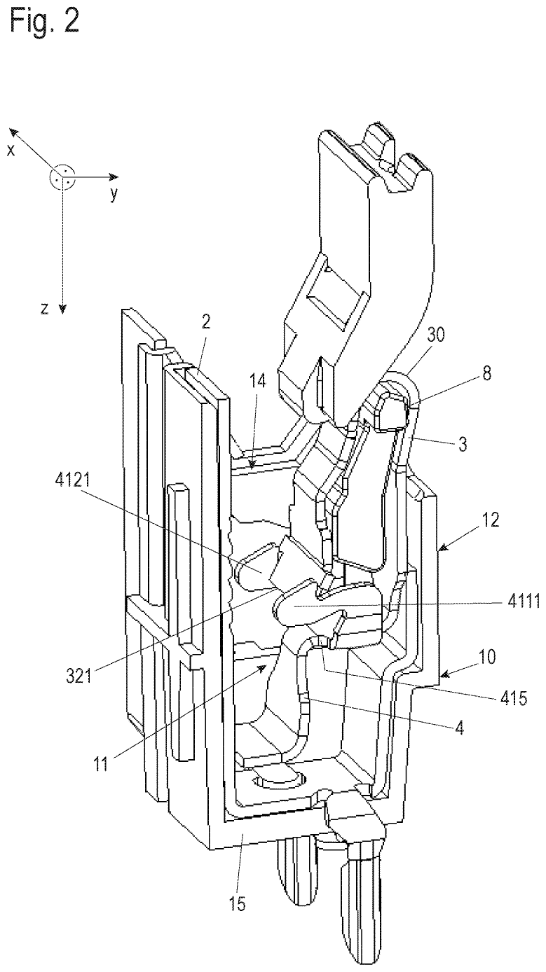

A respective housing lower part 12 can thus have multiple, preferably two, of the receiving chambers 11 arranged side by side in an X-direction, perpendicular to the plane of FIG. 1, which in each case can be wholly or partly separated from one another by one or more intermediate walls 14 (see also FIG. 2).

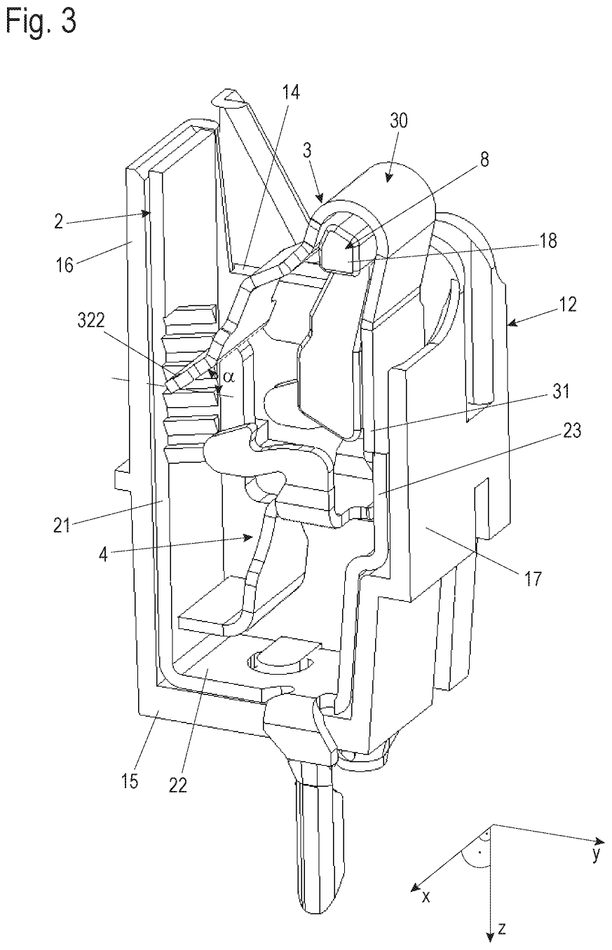

It is advantageous to provide a single partition wall 14 or two parallel partition walls 14 per housing lower part 12 and two of the receiving chambers 11, which are or can be configured to be virtually mirror-inverted with respect to the partition walls 14. They also are open in opposite directions and upwards counter to the conductor insertion direction to mount the respective connection devices well (see FIGS. 2 and 3).

Following this, the housing upper part 13 is put onto close off portions of the housing, not including functional openings, a conductor insertion opening and, if appropriate, an opening for an actuating element, which is described below (see in this respect the exemplary embodiment of FIGS. 7a-7f). The housing upper part can be latched on the housing lower part.

A housing 10 with housing lower part 12 can also have in the Y transverse direction a series of connection devices extending in the X direction. This is clearly depicted in FIGS. 6a-c and 7a-f, with FIGS. 7 a-7f also showing the housing upper part 13. Corresponding receiving chambers 11 are then provided for each series of connection devices in the housing lower part 12, and corresponding partition walls are provided in the housing lower part 12 and in the housing upper part to abide by the necessary air gaps and creepage distances. In this way, plug connectors and/or connection strips can be formed for soldering onto an electrical printed circuit board or the like.

The connection strip can have a plurality of receiving chambers 11 next to one another in the X direction, which can each be completely or partially separated from one another by one or more partition walls 14 (see also FIG. 2). There are preferably two connection strips.

In the housing lower part 12, the respective receiving chamber 11 has an extent in the conductor insertion direction Z, an extent perpendicular thereto in a transverse direction Y, and an extent perpendicular to the transverse direction Y and to the conductor insertion direction Z (here to the drawing plane) in the line-up direction of the receiving chambers 11 (see FIGS. 1, 2 and 3).

The housing upper part preferably has a chamber-like structure with partition walls per pole and terminating walls at one or both ends in line-up direction X. The partition walls each preferably close off the receiving chamber 11 towards a respective side and preferably also engage between the two parallel partition walls 14 of the housing lower part 12. A plurality of these housing lower parts 12 can also be provided next to one another for each housing upper part.

The plastic housing (see FIG. 3) could also be embodied in a pane construction, preferably such that the panes of the individual connections are “clipped” one behind the other and are only finally covered with an extra housing upper part or “cover”, which has the insertion funnels and conductor insertion channels 19.

In particular, a multi-pole pane construction can be realized in this way, wherein an air gap is present between the individual panes in the lined-up state and with which the side walls of an over-housing or of the housing upper part engage (in order to increase the air gaps and creepage distances and in order to close off the housing cleanly towards the top).

In this case, the extent of the respective receiving chamber 11 in the conductor insertion direction Z is preferably more than twice as long, and preferably more than three times as long, as the extent of the respective receiving chamber 11 in the transverse direction Y and in the line-up direction X. In addition, the extent of the respective receiving chamber 11 in the line-up direction X is preferably smaller than the extent in the transverse direction Y. This is because the conductor 6 to be connected can have a relatively small diameter in the region mentioned at the beginning, for example, at 1.5 mm. The total length of the receiving chamber 11 (in relation to housing lower part plus housing upper part with actuation channel for the displaceable actuation mechanism) in the conductor insertion direction Z is typically between 15 mm and 30 mm and the extent in the transverse direction is typically between 7 and 15 mm.

This makes it clear that the elements of the respective spring terminal 1 have a relatively filigree configuration. These elements are correspondingly sensitive in this respect. Spring terminals 1 according to the disclosure, and therefore also the exemplary embodiment of FIG. 1, satisfy this very well.

The busbar 2, of the respective spring force terminal 1 forms an abutment for the electrical conductor 6, which is pressed against the busbar 2 by a clamping spring 3 acting as a compression spring (see FIG. 1).

The electrical conductor 6 has an electrically insulating sheathing 62, which is stripped above a conductor end 63 of the electrical conductor 6, so that a single-wire or multi-wire core 61 of the electrical conductor 6 is visible.

The busbar 2 preferably consists of a highly conductive metal, in particular of a copper alloy.

In addition to its contacting function, the busbar 2 can optionally also assume a further static function as part of a clamping cage. This is explained further below.

For this purpose, the busbar 2 can be configured in an L-shaped or U-shaped manner and preferably consists of a highly conductive metal, in particular of a copper alloy. The busbar 2 preferably has a contact leg 21 which extends substantially in the conductor insertion direction and in the line-up direction. On its narrow side, the busbar 2 can be of relatively thin configuration, for example, less than 0.4 mm thick, and preferably less than 0.3 mm thick. The busbar 21 can also have a transverse leg 22 to limit the conductor insertion path transversely to the conductor insertion direction Z to form a stop for the conductor insertion path.

The busbar 2 can optionally have a further longitudinal leg, an abutment leg 23, which can extend away from the transverse leg 22 parallel to the conductor insertion direction and parallel to the contact leg 21. According to an advantageous configuration, the abutment leg 23 can serve as an abutment or support element for the connection spring. Alternatively, the connection spring can be supported in the housing lower part 12, which can preferably be formed from an electrically insulating plastic. However, any additional support on the metallic busbar 2 is particularly stable and advantageous.

The busbar 2 is configured in a U-shape with respect to the receiving chamber 11, as shown in a side view in FIG. 1.

The busbar 2 can thus be inserted into the receiving chamber 11 and positioned in a way that its transverse leg 22 lies on a base wall 15 in the Z direction, and the contact leg 21 and the longitudinal or abutment leg 23 lie on corresponding inner sides of side walls 16 and 17 of the receiving chamber 11 or of the housing lower part 12.

It can be advantageous that a contact such as a soldering pin or the like or a plug contact such as a pin contact 24 or a contact tulip, which passes through an opening 151 in the base wall 15, is connected integrally to the busbar 2, here to the lower transverse leg 22 in the conductor insertion direction Z. In this way, a first or one of a plurality of metal assemblies can be formed in a simple manner for a connector, in particular a plug connector having one or more plug contacts and respective connection devices for the conductors to be connected. The plug connector can plug into a corresponding mating plug connector, not shown here. It is suitable for use in automation technology but can also be used for other applications. If provided with soldering pins or the like, it can also be soldered onto a printed circuit board or the like and serve as a printed circuit board connector

The clamping spring 3 acting as a compression spring is provided for clamping and contacting the electrical conductor 6 in the spring force terminal 1. It is of substantially V-shaped configuration. The clamping spring 3 has a clamping leg 32, pivotable about a pivot axis 8 in and counter to a pivot direction S (FIG. 1, the arrow S indicates the pivot direction in FIG. 1 to the left upwards to the outside), with a clamping edge 321, by the action of which the electrical conductor 6 contacts the busbar 2 in a permanently electrically conductive manner. The clamping spring 3 thus serves to press the conductor 6 against the contact leg 21 of the busbar 2. The contact leg 21 can optionally have a corrugation or the like in this region.

The clamping leg 32 can have a plurality of bends such that the distance between the clamping leg 32 and the support leg 31 of the clamping spring 3 widens in the transverse direction Y transversely to the conductor insertion direction X in the open and latching position of FIG. 1.

In its last clamping-leg section 322 towards a clamping edge 321, the clamping leg 32 can have a flatter angle α to the transverse direction, which can contribute to optimizing the clamping force or conductor pull-out force (see FIG. 3).

The clamping spring 3 has a support leg 31, with which it is supported in a simple and reliable manner on at least one corresponding abutment during pivoting of the clamping leg 32. The abutment leg 23 of the busbar 2 can serve as this abutment. This abutment leg 23 can be integrally formed on the busbar 2 or bent out. Alternatively, the support leg 31 can be supported in another manner directly in the housing lower part 12.

The support leg 31 and the clamping leg 32 of the clamping spring 3 are preferably connected to one another via an upper bend 30. An advantageous support contour 18 of the terminal housing 12 can engage in the bend 30, the support contour 18 is passed through the bend 30 by the axis of rotation 8 and also serves as a movement limiter for the clamping leg 32 counter to the contacting pivoting direction S. This support contour 18 also assumes an abutment function for supporting the clamping spring 3. The clamping spring 3 is of approximately V-shaped configuration overall. The support contour 18 can be of relatively narrow configuration in the transverse direction Y; for example, its extent in the Y direction can be less than 1.5 mm.

In the conductor insertion direction Z, the injection-molded support contour 18 of the plastic housing extends approximately over more than 70% of the extent of the clamping leg in the conductor insertion direction Z in the open and latching position or latching position of FIG. 1, in which a conductor can be inserted into the connection device.

The pure spring height or spring length of the connection spring in relation to the conductor insertion direction Z can be 5 to 15 mm, preferably 8-12 mm, and very preferably 10 mm.

The width of the clamping spring 32 in the tensioned and in the untensioned state, or the pure spring width in the X direction in the case of zero clamping, is approximately 3 to 7 mm, preferably 4.5 to 5.5 mm, and more preferably 5.1 mm.

The spring opening dimension in the Y transverse direction is approximately 1.3 to 2 mm, preferably 1.5 to 1.8 mm, and more preferably 1.6 to 1.7 mm.

The longitudinal wall 17, on which the abutment leg 23 is also supported in a lower region, has a step. This can make it possible for the receiving chamber 11 to be configured wider in a first region (which is also referred to below as “upper” region) in the transverse direction Y in the conductor insertion direction Z than in a second (“lower”) region in the conductor insertion direction Z. This is advantageous since, due to the pivoting operation of the clamping leg 32, more installation space is required in the first (upper) region in the conductor insertion direction than in the second (lower) region of the receiving chamber 11.

This measure can be supplemented or replaced by the longitudinal wall 17 being shorter towards the top than the opposite longitudinal wall 16, on which the contact leg 21 is supported (see FIGS. 1-4) . As a result, the support leg 31 of the clamping spring 3 can also have a step or bend in its upper region, and the support contour 18 can be arranged and configured in its upper region (that is to say in its first portion in the conductor insertion direction) somewhat further away from the contact leg 21 in the transverse direction Y than in a lower region. This makes it possible for the pivot axis 8 to be spaced apart somewhat further from the contact leg 21 in the transverse direction Y than would be possible if the longitudinal wall 17 were exactly as long as the longitudinal wall 16 parallel thereto.

As a result of one or more of the measures described above, the receiving space tapers significantly in the transverse direction Y downwards in the conductor insertion direction. In the exemplary embodiment shown, the clamping spring 3 is supported in the housing lower part 12 and also on the abutment leg 23.

It is advantageous that the clamping spring 3 is suspended in its upper region, which is first in the conductor insertion direction, mainly in the plastic housing at the spring bend 30 and otherwise is freely movable (FIGS. 1-4) . This results in a better stress distribution in the clamping spring 3 in the open and latching position.

Optionally or alternatively, the clamping spring 3 can be fixed to the busbar clamping cage, which contributes to better mounting and captivity of the connection spring.

In this case, provision can preferably be made for the clamping spring 3 to be suspended on a tab which is raised out of the clamping cage, and which can have, for example, a Y shape to ensure good suspension of the spring while still allowing movement of the clamping spring 3 during actuation.

In this respect, according to FIGS. 1 to 4, the support leg 31 is also additionally supported in a lower region on the busbar 2, on the abutment leg 23. The support leg 31 either simply bears against the abutment leg 23 or can be fixed to the abutment leg 23.

In addition to the clamping spring 3, the retaining spring 4 is provided on the metal assembly of the spring terminal 1. The retaining spring 4 serves to latch a part of the clamping spring 3, namely the clamping leg 32, in an open and latching position, with the result that, in the open and tensioned state of the clamping spring, the conductor can be introduced through an introduction opening in the housing upper part 13 into a contact region K and beyond (see FIG. 1).

The clamping spring 3 is preferably configured in one piece with the retaining spring 4. Alternatively, the retaining spring 4 can be produced separately from the clamping spring 3. The retaining spring 4 can be fixedly connected to the clamping spring 3.

Preferably, the clamping spring arrangement according to FIG. 1 (and FIGS. 2, 5 and 7a to 7f) creates a single-piece component which integrates the functions of the clamping spring 3 and the function of the retaining spring 4. This functionally integrated configuration of the clamping spring 3 with the integrally formed retaining spring 4 is particularly cost-effective and compact and is therefore advantageous, but not compulsory.

In this case, the support leg 31 optionally serves in a functionally integrating manner not only as an additional support leg of the clamping spring 3 but also as a support leg of the retaining spring 4.

A pivotable retaining leg 41 adjoins the support leg 31 in the conductor insertion direction. On this retaining leg 41, one or more retaining mechanisms 411, 412 are configured as latches, on which one or more corresponding counter-retaining mechanism 323, 324 can be latched as counter-latch of the clamping leg 32 of the clamping spring when the clamping leg 32 is pivoted into the open and latching position of FIG. 1, in which the conductor 6 can be introduced into the clamping point K.

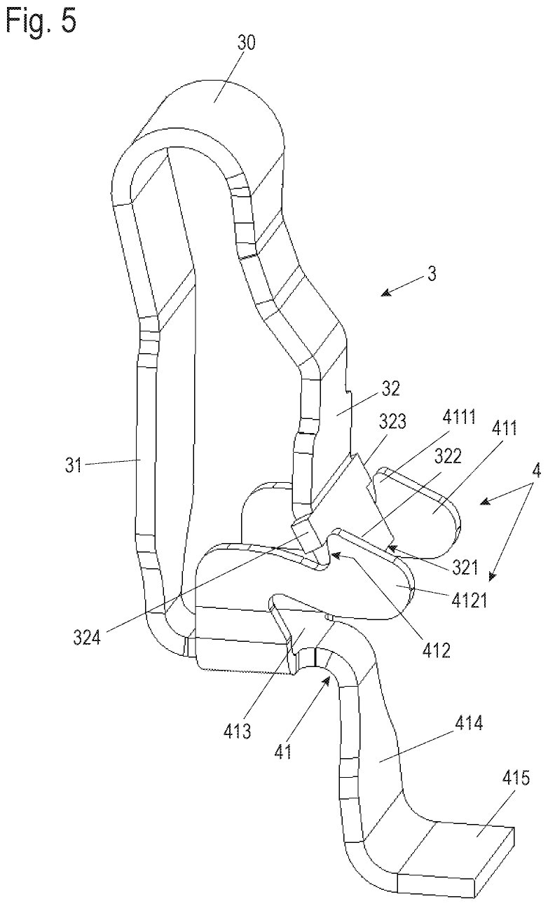

The retaining leg 41 is configured to be stepped one or more times (see in particular FIG. 5).

In this case, the retaining leg 41 can have, below the support leg 31, a first transverse leg section 413 which is aligned in the transverse direction Y (in the Y-/X-plane) and on which the latching mechanisms 411, 412 are configured. The transverse leg section 413 can be adjoined by a longitudinal leg section 414 (FIG. 1) which, in the latched state, extends substantially parallel to the conductor insertion direction and, merges at its end into a further short transverse leg section in the transverse direction Y, which serves as a trigger leg 415 and has a trigger face. If the free end of the conductor 6 strikes this trigger face during introduction, the retaining mechanisms 411, 412 are also pivoted and moved in the conductor insertion direction Z, releasing the latching of the clamping leg 32 on the retaining leg 41, with the result that the clamping leg 31 can relax and press the conductor 6 against the contact leg 21 of the busbar 2.

In this case, the extent of the retaining leg 41 in the conductor insertion direction Z is relatively large, such that the distance between the bend at which the retaining leg 41 is placed on the support leg 31 and the trigger face 415 can be relatively large. A lever with a relatively long lever arm H (see FIG. 1) is therefore formed, the length of which corresponds to this distance and the pivoting of which can release the latching of the clamping leg 32 on the retaining leg 41. The length of the lever arm H can be more than half the length of the clamping leg 32 in relation to the conductor insertion direction Z in the latching and open position. This is advantageous since very small trigger forces can be achieved in this way, and particularly advantageous in view of the small cross-sections of the conductors 6 to be connected, since this stresses the elements of the spring terminal 1 less than in the case with other known designs.

It is also advantageous that, in the tensioned state, the retaining leg 41 and the clamping leg 31 can each be aligned substantially parallel to the conductor insertion channel between the latched clamping leg 32 and the corresponding inner side of the contact leg 21 in each case at least over a substantial part of their length, which promotes a very narrow design, in particular in the transverse direction Y.

As retaining and latching mechanisms 411, 412, two latching wings can be provided on the retaining leg 41, which are preferably cut to size from the integral spring plate used for forming the clamping spring 3 and retaining spring 4, and then bent out. The latching wings can project laterally from the narrow sides of the retaining leg 41 and be bent over upwards through 90° from there. These latching wings then extend substantially in planes parallel to the Y-/Z-plane. At their ends, the latching wings have latching hooks 4111, 4121 with latching edges. These latching hooks 4111, 4121 preferably extend substantially or exactly parallel and counter to the conductor insertion direction Z. The trigger forces can therefore be kept low as a result, since only a slight pivoting of the retaining leg 41 is necessary in order to release the latching edges.

The latching edges can be relatively short, for example, 0.3 to 1 mm long. The latching hooks 4111, 4121 can engage behind lateral latching webs 323, 324 of the clamping leg 32. The latching webs serve as counter-retaining mechanisms and counter-latching mechanisms, and are spaced apart from the clamping edge 321, counter to the conductor insertion direction Z.

As a result of the selected construction, the latching hooks 4111, 4121 can be released from the latching position in a simple and material-saving manner by only slight pivoting and with little force.

The counter-retaining and counter-latching mechanism in the form of the latching webs 323, 324 are spaced apart from the clamping edge 321, such that they cannot be damaged by the latching operations.

The two hook-shaped retaining elements 411, 412 on the retaining leg 41, which are bound laterally to the retaining leg 41 and then shaped upwards in the direction of the conductor insertion channel as latching hooks 4111, 4121 in order to latch with the counter-retaining elements, the latching webs 323, 324 on the clamping leg 32, are particularly advantageous. This is because, although the installation space is very small, the clamping spring 3 must not be compressed to such an extent that it (in particular the bending region) does not come into the plastic region and relaxes and therefore loses clamping force over time. The selected configuration effectively counteracts this.

The retaining mechanisms 411, 412 form a latching connection with the counter-retaining mechanisms 323, 324 in the open and latching position of the clamping leg 32. In this way, the clamping spring 3 can be latched in a simple manner in the open and latching position, from which it can easily be released when the conductor 6 is introduced by pushing it in.

A pusher 5, or actuator, guided in the housing upper part 13 can be used as actuating element 5 for pivoting the clamping leg 32 back into the open and latching position. The pusher is preferably guided in an actuation channel 101 of the housing upper part 13 and can be pressed down from the outside, for example using a screwdriver.

The pusher 5 can for the most part be located above the clamping spring 3. When pressed in the conductor insertion direction Z, which is also its conductor insertion direction, it is pressed parallel to the conductor insertion direction Z onto an actuation region of the clamping leg 32, which can be located in the transverse direction Y between the clamping edge 321 and the axis of rotation 8. This actuation region of the clamping leg 32 is configured here in the region of the bend, i.e. in a region in which the bend 30, which describes approximately a 180° arc, merges into the clamping leg 32.

The actuating element pusher 5 advantageously acts on the clamping leg 32 of the clamping spring 3 in a region which is uppermost in the conductor insertion direction, in particular in the first half of the clamping leg, as seen from the bending region, in order to press it back, counter to the pivot direction S from a relaxed position, in a clamping position (without or with conductor 6, see FIGS. 7c-7f) , into the open and latching position of FIG. 1 or of FIG. 6a-c or 7a and 7b. This is advantageous for realizing a narrow design, since the pusher 5 does not have to extend very far into the housing 10 or here the housing upper part 13 as a result (see FIGS. 7a-7f). This also helps to realize a compact design which is narrow, in particular in the transverse direction Y.

According to one variant, the actuating element 5, or here the pusher, is preferably arranged substantially above or over the axis of rotation 8 of the clamping spring 3 and it is actuated in the vertical direction, that is, in the conductor insertion direction Z or parallel thereto. However, it is not substantially cuboidal, but rather has a base leg 50 which is oriented in the housing 10 parallel to the conductor insertion direction Z and merges into an actuation leg 51 which is angled obliquely with respect to the conductor insertion direction Z or with respect to the conductor insertion direction towards the clamping leg 32, and with which the pusher 5 acts on the clamping spring 3 in the region of the bend 30. This entails the advantage that installation space is saved since the insertion funnel for the conductor 6 which is situated adjacent thereto can be configured as large as possible in order to be able to connect as many conductor cross sections as possible.

In summary, a single-piece spring is created, with a clamping spring 3 and a retaining spring 4, having a clamping leg 32 and a retaining leg 41 respectively, wherein a trigger element, here the transverse leg and trigger leg 415, is arranged at the end of the retaining leg 41 on a relatively long lever arm.

According to FIG. 1, the entire spring with the clamping spring 3 and the retaining spring 4 is supported on the clamping cage at least at one point on the busbar 2 or on the clamping cage which it forms by its U shape, which is advantageous.

This is also advantageous in particular since, in the case of single-piece springs with a clamping spring 3 and a retaining spring 4, in contrast to two-piece springs with a clamping spring 3 and a retaining spring 4, the actuating force is higher since, during tensioning, the resistance of the retaining leg 41 has to be overcome and the tensions in the spring are higher. However, production and mounting are simpler and less complex since only a single spring has to be mounted and since a closed force system is formed in the tensioned state.

The actuating face of the transverse and trigger leg 415 or of the trigger element is advantageously located below the connection of the retaining mechanism 411, 412.

Locking takes place in the lowermost third of the clamping leg 32. This is advantageous on account of the selected narrow design.

It is also advantageous for the two retaining mechanisms 411, 412 to be placed laterally on the outer edges of the retaining leg 41 since, on account of the small dimensions of the connection device, there is only sufficient wide strip of raw material on the outside to implement these functional mechanisms.

The edges of the retaining mechanisms 411, 412 and latching webs 323, 324 can optionally be configured in a rounded manner, with the result that the extension of the clamping leg 32 can slide along them better during actuation to the latching position, which is advantageous in order to implement as little force as possible during actuation.

The respective locking points V (see FIG. 1) between the respective latching webs 323, 324 of the clamping leg 32 of the clamping spring 3 and the respective retaining mechanisms 411, 412 are also advantageously located in the transverse direction Y between the conductor insertion channel and the connection points of the retaining mechanism 411, 412 on the retaining spring 41 (here on the transverse-leg section 415 thereof). They are configured to have a relatively large area so that the clamping spring is not “compressed” too much. This advantageously contributes, amongst other things, to a narrow design.

The selected latching is also advantageously configured in such a way that the retaining leg 41 and the clamping leg 32 are arranged virtually parallel to one another in the open and latching position, which counteracts overstretching of the spring. The deviation from the orientation parallel to the contact section 21 of the busbar 2, on the longitudinal leg 414 of the retaining spring and on a parallel-leg section 325 of the clamping leg 32 (FIG. 1) which, in the latched state, is located parallel to the conductor insertion direction Z and to the contact leg 21 of the busbar 2, is preferably less than 25°, in particular less than 20°. The parallel-leg section 325 of the clamping leg 32 is located in front of the clamping-leg section 322 in the conductor insertion direction Z, and the clamping-leg section 322 is in turn adjoined by the contact edge 321.

The clamping spring 3 preferably has a width-to-height ratio Y/Z of at least 2 to 1, preferably at least 3 to 1, in the tensioned state. This is advantageous since the overall width Y is limited.

In this way, the trigger forces of the system can be defined very well and kept low.

In principle, the above features can also be implemented in the exemplary embodiments of FIGS. 6a-6c and 7a-7f. These exemplary embodiments each disclose a somewhat different arrangement and suspension of the connection spring in the housing 10 than in FIG. 1. On the other hand, they also disclose features (such as the clamping positions with unlatched clamping spring 32 once with contacted conductor 6 and once without contacted conductor 6) which also occur correspondingly in FIGS. 1 to 4.

In FIGS. 6a to 6c, the plastic housing's support contour 18 which is injection-molded onto the housing lower part 12 and which serves for supporting and suspending the clamping spring 3 can be clearly seen.

In FIGS. 7a to 7c, the support and suspension of the clamping spring 3 is realized not by a support contour 18 of the plastic housing which is injection-molded onto the housing lower part 12, but by a support web 231 of the busbar 2 which serves for supporting and suspending the clamping spring 3. The support web 231 can be configured on the abutment leg 23 of the busbar and can be the entire upper end of the abutment leg 23 of the busbar 2 or a support web which is partially cut out and bent out of this.

The metal elements and the pusher 5 are each not shown here in the receiving chambers 11 on the right in FIGS. 7a-7f. These receiving chambers 11 can also be configured to be mirror-inverted with respect to a central partition wall (extending in the X-Z plane).

What is claimed is:

1. Connection device, configured as a direct plug-in spring force terminal, for connecting a conductor, comprising:
a. a housing including a receiving chamber having a conductor insertion opening;
b. a busbar for contacting an electrical conductor;
c. a connection spring having an approximately V-shaped clamping spring being a compression spring for fixing the electrical conductor in the spring force terminal and having a retaining spring for latching the clamping spring in an open and latching position, the conductor being insertable into a contact region in a conductor insertion direction via a conductor insertion channel;
d. the clamping spring and retaining spring comprising one piece, the clamping spring having a clamping leg being pivotable in and counter to a pivot direction via a clamping edge and the retaining spring having a pivotable retaining leg releasably latched on the clamping leg;
e. an actuator for pivoting the clamping leg counter to the pivot direction from a clamping state into the open and latching position by displacing the actuator;
f. the retaining leg having two retaining latches and the clamping leg having two corresponding counter-retaining portions as counter-latches for interaction with the retaining latches of the pivoting leg in the open and latching position of the clamping leg, wherein the clamping leg can be unlatched from the retaining leg retaining latches by displacing the electrical conductor n a conductor insertion direction to press the electrical conductor with the clamping edge of the clamping leg against the busbar;
wherein
g. each of the respective retaining latches of the retaining leg include two latching wings projecting laterally from opposite narrow sides of a transverse-leg section of the retaining leg, the transverse-leg section being aligned transversely to the conductor insertion direction the latching wings being bent over counter to the conductor insertion direction; and
h. the latching wings including latching hooks having latching edges arranged in the direction of the conductor insertion channel which can be latched on latching webs of the clamping leg as the counter-latch.

2. The connection device according to claim 1, wherein the latching webs project laterally from narrow sides of the clamping leg.

3. The connection device according to claim 1, wherein the two latching wings which project laterally from opposite narrow sides of a transverse-leg section of the retaining leg extend in planar substantially parallel planes.

4. The connection device according to claim 1, wherein the clamping leg of the clamping spring and the retaining leg of the retaining spring each have at least one leg section aligned to lie substantially parallel to one another in the open and latching position, the leg sections extending substantially in the conductor insertion direction and in a direction perpendicular thereto.

5. The connection device according to claim 1, wherein the counter-latches of the clamping leg are spaced apart from the clamping edge of the clamping leg counter to the conductor insertion direction, the retaining latches of the pivoting leg being indirectly latched on the clamping edge of the clamping leg.

6. The connection device according to claim 1, wherein the clamping spring has a support leg for supporting the clamping spring on a corresponding abutment of the housing, the busbar, or both.

7. The connection device according to claim 1, wherein the busbar has a U-shape in a side view and forms a clamping cage having a contact leg, a base leg and an abutment leg.

8. The connection device according to claim 7, wherein the receiving chamber of the housing tapers in the conductor insertion direction and the U-shaped clamping cage tapers out of the busbar in the conductor insertion direction.

9. The connection device according to claim 6, wherein the clamping spring has a bend extending over approximately 180° to connect the clamping leg to the support leg, wherein the actuator acts on the bend or on a transition region between the bend and the clamping leg when the open and latching position is restored.

10. The connection device according to claim 6, wherein the clamping leg has a plurality of bends such that the distance between the transverse leg and the support leg of the clamping spring widens perpendicularly to the conductor insertion direction in the transverse direction in the open and latching position.

11. The connection device according to claim 9, wherein the bend extends in the transverse direction into a region located above an upper end of the abutment leg of the clamping cage out of the busbar.

12. The connection device according to claim 1, wherein the actuator acts on the actuating leg above an axis of rotation of the clamping spring.

13. The connection device according to claim 1, wherein the actuator acts on a point of the clamping leg located in the first half of the actuating leg in the conductor insertion direction.

14. The connection device according to claim 12, wherein the actuator is arranged substantially above the axis of rotation of the clamping spring.

15. The connection device according to claim 1, wherein the actuator has a base leg in the conductor insertion direction oriented in the housing parallel to the conductor insertion direction Z, the base leg merging into an actuation leg angled obliquely relative to the conductor insertion direction Z or the conductor insertion direction towards the clamping leg to act on the clamping spring.

16. The connection device according to claim 1, wherein the clamping spring has a length in the conductor insertion direction when in the open and latching position with the clamping leg stressed more than twice as great as a distance between the clamping edge and an abutment leg in a transverse direction transversely to the conductor insertion direction.

17. The connection device according to claim 1, wherein the retaining leg of the retaining spring forms a lever arm which is more than half as long as the clamping leg in the conductor insertion direction in the tensioned state.

18. The connection device according to claim 1, wherein a spring height of the connection spring in relation to the conductor insertion direction is 8-12 mm.

19. A series terminal, plug connector or connection strip comprising one or more connection devices according to claim 1.

20. The series terminal, plug connector or connection strip according to claim 19 having a pane-shaped structure.

21. The series terminal, plug connector or connection strip according to claim 19, wherein one or more connection devices includes a plurality of connection devices, two connection devices sharing a housing base part, each connection device being arranged in receiving chambers open toward opposite directions of the housing base part.

22. The series terminal, plug connector or connection strip according to claim 21, wherein a housing upper part has a chamber-like structure including walls to separate the receiving chambers of the respective housing base part toward opposite sides and in the middle.
